(19) United States
(12) Patent Application Publication
(10) Pub. No.: US 2019/0271450 A1
(43) Pub. Date: Sep. 5, 2019

(54) LAMP ASSEMBLY

(71) Applicant: GM GLOBAL TECHNOLOGY OPERATIONS LLC, Detriot, MI (US)

(72) Inventors: Robert Dallos, Jr., Canton, MI (US); Xiaosong Huang, Novi, MI (US); Shannen M. Borngesser, Macomb Township, MI (US); Mark R. Gordon, Warren, MI (US)

(73) Assignee: GM GLOBAL TECHNOLOGY OPERATIONS LLC, Detroit, MI (US)

(21) Appl. No.: 15/911,943

(22) Filed: Mar. 5, 2018

(51) Int. Cl. F21S 45/60; F21S 45/50; F21S 41/20; H05B 3/84

(52) U.S. Cl. CPC F21S 45/60; F21S 45/50; H02S 40/38; H05B 3/84; F21S 41/285

(57) ABSTRACT

A lamp assembly includes a housing forming an interior space, and having a first portion and a second portion. A light source is disposed within the interior space and positioned to direct light through the first portion. An electrically resistive coating is disposed on the first portion of the housing, and is operable to heat the first portion to create a positive temperature gradient in which the first portion exhibits a higher temperature than the second portion so that moisture within the interior space condenses on the second portion and not the first portion. A self-contained power supply, including an energy storage device and a solar cell, may be incorporated into the housing. An interior surface of the first portion may be coated with a hydrophobic coating, and an interior surface of the second portion may be coated with a hydrophilic coating.

### INTRODUCTION

The disclosure generally relates to a lamp assembly

A lamp assembly, such as used in vehicles, includes a housing that encloses a light source within an interior space. The light source produces light, which is directed outward through a portion of the housing, often referred to as a lens or a cover. In response to certain thermal conditions, moisture within the interior space of the housing may condense on interior surfaces of the housing, including the lens through which the light is directed. Condensation on the lens may reduce light transmission through the lens. Additionally, condensation on portions of the housing visible from an exterior of the lamp assembly may provide un-desirable aesthetics.

### SUMMARY

A lamp assembly is provided. The lamp assembly includes a housing forming an interior space. The housing includes a first portion and a second portion. A heating element is affixed to the first portion of the housing. The heating element is operable to heat the first portion for creating a positive temperature gradient between the first portion and the second portion. The positive temperature gradient occurs when the first portion exhibits a higher temperature than the second portion. The heating element is used to generate the positive temperature gradient so that moisture within the interior space condenses on the second portion, and not the first portion.

In one aspect of the lamp assembly, the first portion may be considered a lens that is visible from an exterior of the lamp assembly and through which light is transmitted, and the second portion may be considered a casing that supports the lens and is generally hidden from view from the exterior of the lamp assembly.

In one embodiment of the lamp assembly, the first portion and the second portion of the housing each include an interior surface facing the interior space of the housing, with the heating element disposed adjacent the interior surface of the first portion, within the interior space of the housing.

In one embodiment of the lamp assembly, the heating element includes an electrically resistive element that is operable to generate heat in response to an applied electric current. The electrically resistive element may include a translucent coating applied to the interior surface of the first portion of the housing. The electrically resistive element may include, for example, one of a conductive polymer, a conductive nanotube, or a conductive nanofiber.

In one aspect of the lamp assembly, a light source is disposed within the interior space and is supported by the housing. The light source is positioned to direct light through the first portion of the housing.

In one embodiment of the lamp assembly, a power supply is electrically connected to the heating element. The power supply is operable to supply an electric current to the heating element. The power supply may include an energy storage device capable of storing electrical energy. Additionally, the power supply may include a solar cell for converting light energy into electrical energy. The solar cell may capture light energy and convert it into electrical energy which is stored in the energy storage device. The heating element may then draw the electrical energy from the energy storage device to heat the first portion of the housing. In one embodiment of the lamp assembly, the power supply, including the energy storage device and the solar cell, is self-contained within the housing.

In one embodiment of the lamp assembly, a hydrophobic coating is disposed adjacent an interior surface of the first portion of the housing. The heating element is disposed between the hydrophobic coating and the first portion of the housing. The hydrophobic coating repels condensation from the first portion of the housing.

In another embodiment of the lamp assembly, a hydrophilic coating is disposed adjacent an interior surface of the second portion of the housing. The hydrophilic coating attracts condensation to the second portion of the housing.

In another aspect of the lamp assembly, the housing includes a drain for draining condensate disposed on the second portion of the housing, within the interior space. The drain may include an opening in the housing disposed at a low elevation of the interior space. Fluid flow through the opening may be controlled by a one-way valve and/or filter material.

Accordingly, the heating element may be used to heat the first portion of the housing in order to create the positive temperature gradient between the first portion and the second portion, in which the first portion is warmer than the second portion. Condensation will form on the second portion of the housing and not the first portion of the housing, because the temperature of the second portion is less than the temperature of the first portion. Accordingly, the location within the interior space of the housing at which condensation forms may be controlled. For example, the first portion may be defined as a lens of the housing, or as some other portion of the housing that is visible from an exterior of the lamp assembly. The heating element may be positioned over the lens so that condensation does not form on the lens and does form on the interior surfaces of the housing that do not affect light transmission and that are not otherwise visible from the exterior of the lamp assembly.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a lamp assembly

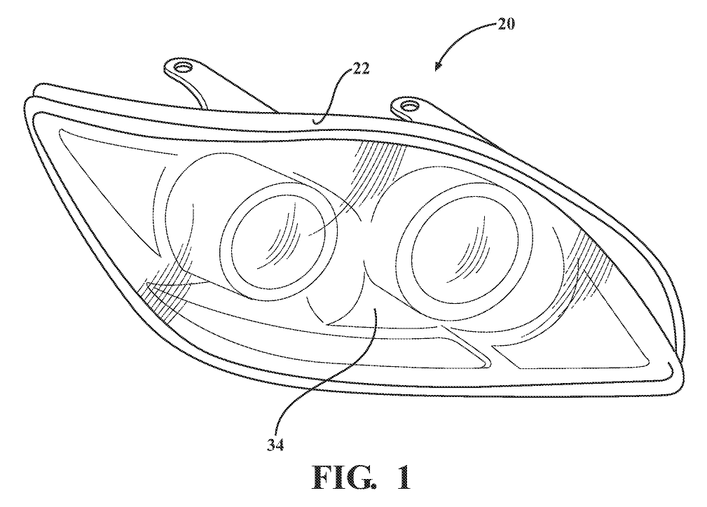

FIG. 2 is a schematic cross sectional view of the lamp assembly.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the FIGS., wherein like numerals indicate like parts throughout the several views, a lamp assembly is generally shown at 20. The lamp assembly 20 may be incorporated into a vehicle, such as but not limited to, a car, a truck, a van, a train, an airplane, an ATV, a motorcycle, a snowmobile, or some other moveable platform. Additionally, it should be appreciated that the lamp assembly 20 may also be incorporated into some other, non-moveable manufacture and/or structure. The exemplary embodiment of the lamp assembly 20 described herein is embodied as a headlight assembly for a vehicle.

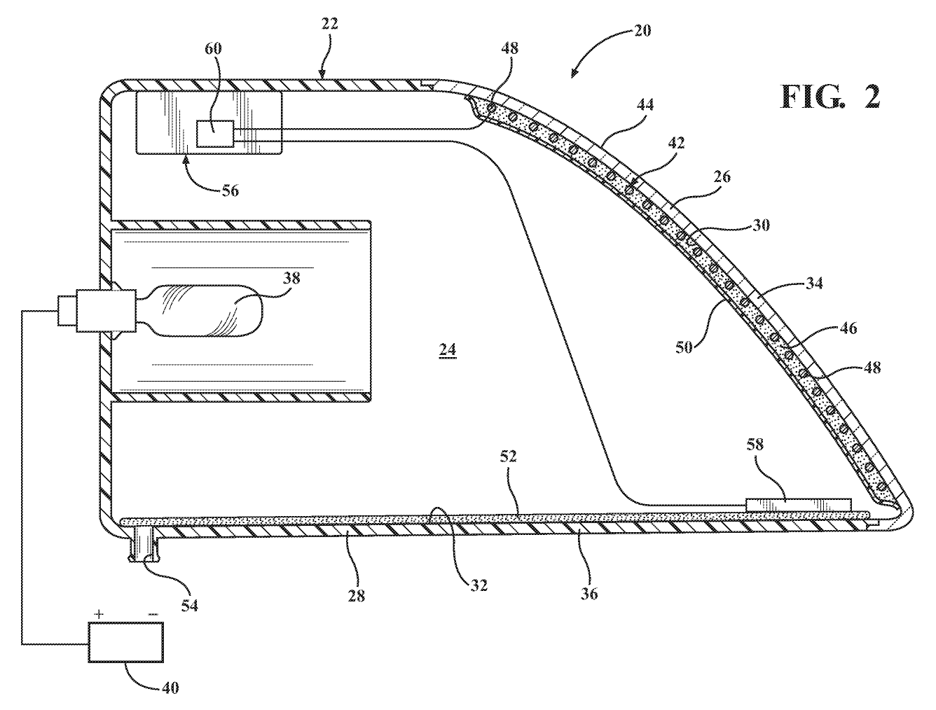

Referring to FIG. 2, the lamp assembly 20 includes a housing 22. The housing 22 forms an interior space 24, and includes at least a first portion 26 and a second portion 28. The first portion 26 includes an interior surface 30, and the second portion 28 includes an interior surface 32. The interior surfaces 30, 32 of the first portion 26 and the second portion 28 face the interior space 24 of the housing 22.

The housing 22 may be formed from several different components attached together. For example, in the exemplary embodiment of the headlight assembly shown in the Figures and described herein, the housing 22 may be formed from a lens 34 and a case 36. The lens 34 may be referred to as the first portion 26, and the case 36 may be referred to as the second portion 28. While the exemplary embodiment described herein includes the first portion 26 and the second portion 28 being different components, i.e., the lens 34 is defined as the first portion 26, and the case 36 is defined as the second portion 28, it should be appreciated that in other embodiments of the lamp assembly 20, the first portion 26 and the second portion 28 of the housing 22 may be defined differently than the exemplary embodiment described herein. For example, the first portion 26 of the housing 22 may be defined as a central portion of the lens 34, and the second portion 28 of the housing 22 may be defined as an exterior or outer edge portion of the lens 34. As such, it should be appreciated that the first portion 26 and the second portion 28 of the housing 22, may each include separate and distinct portions of the same component, e.g., the lens 34 or the case 36. Additionally, while a single first portion 26 and a single second portion 28 are described herein, it should be appreciated that the lamp assembly 20 may include multiple first portions 26 and multiple second portions 28 as described herein in accordance with the teachings of this disclosure.

In the exemplary embodiment described herein, the lens 34 may be constructed of a generally transparent or translucent material through which light is transmitted. For example, the lens 34 may be constructed from, but is not limited to, a polycarbonate or other similar material. The case 36 supports the lens 34, and may be used to attach the lamp assembly 20 to a structure, such as a body structure of a vehicle (not shown). The case 36 may be constructed from a transparent or translucent material, but may alternatively be constructed from an opaque material. The case 36 may be constructed from, but is not limited to, a polyacrylic or other similar material. The lens 34 and the case 36 of the exemplary embodiment are attached together to form the housing 22.

A light source 38 is disposed within the interior space 24 and supported by the housing 22. The light source 38 may be supported by the housing 22 in any suitable manner. For example, the light source 38 may be attached to a holder, which is in turn attached to the case 36. The light source 38 may include a device capable of generating light, such as but not limited to an incandescent light, a fluorescent light, an LED light, or some other similar device. In the exemplary embodiment shown in the Figures and described herein, the light source 38 is positioned to direct light through the first portion 26 of the housing 22, i.e., the lens 34. An exterior power source 40 may be connected to the light source 38 to supply the light source 38 with electricity in order to generate light.

The interior space 24 of the housing 22 is a generally closed and substantially (although not completely) sealed chamber. Condensation is the change of the physical state of matter from a gas phase into a liquid phase. As air cools, the amount of moisture capable of being suspended in the air decreases. As such, condensation often occurs when air having a high relative humidity comes in contact with a cool surface, and is thereby cooled, causing the moisture in the air to condense onto the cool surface. Because the interior space 24 of the housing 22 is a generally closed chamber that is not well ventilated, water vapor suspended in the air within the interior space 24 may condense on the interior surfaces 30, 32 of the housing 22 under certain thermal conditions.

In order to control the location of potential condensation on the interior surfaces 30, 32 of the housing 22, a heating element 42 is affixed to the first portion 26 of the housing 22. The heating element 42 is operable to heat the first portion 26 in order to create a positive temperature gradient between the first portion 26 and the second portion 28. As used herein, the phrase “positive temperature gradient” is defined as the first portion 26 of the housing 22 exhibiting a higher surface temperature on the interior surface 30 of the first portion 26 than a surface temperature of the interior surface 32 of the second portion 28 of the housing 22. The positive temperature gradient causes moisture suspended in the air within the interior space 24 of the housing 22 to condense on the interior surface 32 of the second portion 28 of the housing 22, because the surface temperature of the interior surface 32 of the second portion 28 is less than the surface temperature of the interior surface 30 of the first portion 26. By driving condensation onto the second portion 28 of the housing 22, the positive temperature gradient prevents or limits condensation formation on the first portion 26 of the housing 22.

In the exemplary embodiment shown in the Figures and described herein, the heating element 42 is disposed adjacent the interior surface 30 of the first portion 26, within the interior space 24 of the housing 22. However, in other embodiments, it is contemplated that the heating element 42 may be disposed adjacent an exterior surface 44 of the first portion 26, outside of the interior space 24 of the housing 22. The heating element 42 may include a device capable of heating the first portion 26, while allowing light transmission therethrough. For example, the heating element 42 may include, but is not limited to, a translucent coating 46 applied to the interior surface 30 of the first portion 26 of the housing 22, and having electrically resistive element 48 that is operable to generate heat in response to an applied electric current. The features of the heating element 42 shown in FIG. 2 are not to scale, and are shown enlarged for clarity. Additionally, the thickness of the translucent coating 46 is also not shown to scale, and is shown enlarged for clarity.

The electrically resistive element 48 of the translucent coating 46 may include, but is not limited to, a conductive polymer, such as but not limited to, poly (3,4-ethylenedioxythiophene) polystyrene sulfonate (PEDOT:PSS), a conductive nanotube such as a carbon nanotube, indium tin oxide (ITO), or a conductive nanofiber, such as but not limited, to a Silver nanowire. In the exemplary embodiment described herein, the translucent coating 46 allows at least 75% visible light transmission therethrough. However, in other embodiments, the amount of light transmission through the translucent coating 46 may be less.

A hydrophobic coating 50 may be applied to the interior surface 30 of the first portion 26 of the housing 22. As shown in the exemplary embodiment, the hydrophobic coating 50 is applied over the heating element 42, such that the heating element 42 is disposed between the hydrophobic coating 50 and the first portion 26 of the housing 22. The hydrophobic coating 50 may include a coating or layer of a substance that is operable to repel water, e.g., condensation, and that is also transparent or translucent. Accordingly, the hydrophobic coating 50 acts to repel water, e.g., condensation, from the first portion 26 of the housing 22. Additionally, a hydrophilic coating 52 may be applied to the interior surface 32 of the second portion 28 of the housing 22. The hydrophilic coating 52 may include a coating or layer of a substance that is operable to attract water, e.g., condensation. The thickness of the hydrophobic coating 50 and the hydrophilic coating 52 are not shown to scale, and are shown enlarged for clarity.

The housing 22 may include a drain 54 for draining condensate from within the interior space 24 of the housing 22. The drain 54 may be positioned at any location within the housing 22. As shown in the exemplary embodiment, the drain 54 is disposed in the second portion 28 of the housing 22, within the interior space 24, at a low elevation section. As such, condensate that forms on the interior surface 32 of the second portion 28 may flow downward toward the drain 54 via gravity, and then exit the interior space 24 through the drain 54. Fluid flow through the drain 54 may be controlled by a one way valve or filter to prevent or limit moisture and debris from entering the interior space 24 of the housing 22.

The lamp assembly 20 may further include a power supply 56. The power supply 56 is electrically connected to the heating element 42, and is operable to supply an electric current to the heating element 42 so that the heating element 42 may generate heat. In the exemplary embodiment shown in the Figures and described herein, the power supply 56 is self-contained within the housing 22. In the exemplary embodiment described herein, the power supply 56 includes a solar cell 58 for converting light energy into electrical energy, and an energy storage device 60 capable of storing electrical energy. The solar cell 58 may include, but is not limited to, an amorphous or crystalline solar cell 58. The energy storage device 60 may include, but is not limited to, a battery, a capacitor, or other similar device capable of storing electrical energy. The solar cell 58, the energy storage device 60, and the heating element 42 are connected in a circuit. The power supply 56 may further include additional components to control the current through the circuit, in order to control activation of the heating element 42.

In operation, the solar cell 58 may be used to capture light energy and convert the light energy into electrical energy, which is stored in the energy storage device 60. The solar cell 58 may capture the light energy from the light source 38, and/or may capture natural light shining through the housing 22 into the interior space 24. The heating element 42 may then draw the electrical energy from the energy storage device 60 to warm the first portion 26 of the housing 22. The heating element 42 may be energized with an electric current to generate heat through resistance. The heat generated by the heating element 42, which is disposed adjacent the first portion 26 of the housing 22, warms the first portion 26 of the housing 22, relative to the second portion 28 of the housing 22, which is not near the heating element 42. Accordingly, heating the first portion 26 of the housing 22 and not the second portion 28 of the housing 22 creates the positive temperature gradient, in which the first portion 26 of the housing 22 is warmer than the second portion 28 of the housing 22. When conditions are conducive to condensation formation, moisture suspended in the air within the interior space 24 of the housing 22 will condense on the cooler interior surface 32 of the second portion 28 of the housing 22, and will not condense on the warmer interior surface 30 of the first portion 26 of the housing 22. Accordingly, the location of condensation formation is controlled by heating the first portion 26 of the housing 22 and creating the positive temperature gradient. The condensate that forms on the second portion 28 may exit the interior space 24 through the drain 54 in the housing 22. In the exemplary embodiment shown in the Figures, by configuring the first portion 26 of the housing 22 as the lens 34, and the second portion 28 of the housing 22 as the case 36, condensation is controlled to form on the interior surface 32 of the case 36, and not the interior surface 30 of the lens 34, thereby keeping the lens 34 clear to transmit light therethrough, and keeping the condensation hidden from view from the exterior of the lamp assembly 20.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A lamp assembly comprising:
a housing forming an interior space and having a first portion and a second portion; and
a heating element affixed to the first portion of the housing and operable to heat the first portion for creating a positive temperature gradient between the first portion and the second portion in which the first portion exhibits a higher temperature than the second portion so that moisture within the interior space condenses on the second portion and not the first portion.

2. The lamp assembly set forth in claim 1, wherein the first portion and the second portion of the housing each include an interior surface facing the interior space of the housing, with the heating element disposed adjacent the interior surface of the first portion, within the interior space of the housing.

3. The lamp assembly set forth in claim 1, wherein the heating element includes an electrically resistive element that is operable to generate heat in response to an applied electric current.

4. The lamp assembly set forth in claim 3, wherein the electrically resistive element includes a translucent coating applied to an interior surface of the first portion of the housing.

5. The lamp assembly set forth in claim 4, wherein the electrically resistive element includes one of a conductive polymer, a conductive nanotube, or a conductive nanofiber.

6. The lamp assembly set forth in claim 1, further comprising a light source disposed within the interior space and supported by the housing, wherein the light source is positioned to direct light through the first portion of the housing.

7. The lamp assembly set forth in claim 1, further comprising a power supply electrically connected to the heating element and operable to supply an electric current to the heating element.

8. The lamp assembly set forth in claim 7, wherein the power supply includes an energy storage device capable of storing electrical energy.

9. The lamp assembly set forth in claim 7, wherein the power supply includes a solar cell for converting light energy into electrical energy.

10. The lamp assembly set forth in claim 7, wherein the power supply is self-contained within the housing.

11. The lamp assembly set forth in claim 1, further comprising a hydrophobic coating adjacent an interior surface of the first portion of the housing.

12. The lamp assembly set forth in claim 11, wherein the heating element is disposed between the hydrophobic coating and the first portion of the housing.

13. The lamp assembly set forth in claim 1, further comprising a hydrophilic coating disposed adjacent an interior surface of the second portion of the housing.

14. The lamp assembly set forth in claim 1, wherein the housing includes a drain for draining condensate disposed on the second portion of the housing within the interior space.

15. A lamp assembly for a vehicle, the lamp assembly comprising:
a housing forming an interior space and having a first portion and a second portion, wherein each of the first portion and the second portion include an interior surface facing the interior space of the housing;
a light source disposed within the interior space and supported by the housing, wherein the light source is positioned to direct light through the first portion of the housing;
an electrically resistive coating disposed on the interior surface of the first portion of the housing, wherein the electrically resistive coating is operable to heat the first portion for creating a positive temperature gradient between the first portion and the second portion in which the first portion exhibits a higher temperature than the second portion so that moisture within the interior space condenses on the second portion and not the first portion; and
wherein the housing includes a drain for draining condensate disposed on the second portion of the housing within the interior space.

16. The lamp assembly set forth in claim 15, wherein the electrically resistive coating includes a translucent coating having one of a conductive polymer, a conductive nanotube, or a conductive nanofiber.

17. The lamp assembly set forth in claim 15, further comprising a power supply electrically connected to the electrically resistive coating and operable to supply an electric current to the electrically resistive coating, wherein the power supply is self-contained within the housing.

18. The lamp assembly set forth in claim 17, wherein the power supply includes an energy storage device capable of storing electrical energy, and a solar cell for converting light energy into electrical energy.

19. The lamp assembly set forth in claim 15, further comprising a hydrophobic coating disposed adjacent to the interior surface of the first portion of the housing.

20. The lamp assembly set forth in claim 15, further comprising a hydrophilic coating disposed adjacent to the interior surface of the second portion of the housing.
